(19) United States
(12) Patent Application Publication
(10) Pub. No.: US 2004/0011762 A1
(43) Pub. Date: Jan. 22, 2004

(54) Method for manufacturing master disk for manufacturing optical recording medium havingpits and projections, stamper, and optical recording medium

(76) Inventor: Motohiro Furuki, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/344,232

(22) PCT Filed: Jun. 11, 2002
(86) PCT No.: PCT/JP02/05803

(30) Foreign Application Priority Data
Jun. 11, 2001 (JP) 2001-175982

(51) Int. Cl. B29D 11/00

(52) U.S. Cl. 216/24

(57) ABSTRACT

A manufacturing method of a master disk for fabricating an optical recording medium having unevenness includes a step of forming a photoresist layer 2 on a surface of a substrate 1, having a fine pattern corresponding to the unevenness, a first etching step of forming unevenness 3 on the surface of the substrate by using the photoresist layer as a mask and using reactive ion etching, and a second etching step of conducting oxygen ion etching on the substrate 1 after the first etching step. By thus improving the surface property and removing sharp subtrenches, the disk noise is improved.

### TECHNICAL FIELD

The present invention relates to manufacturing methods of a master disk for fabricating an optical recording medium having unevenness in which disk noises are improved, a stamper for fabricating an optical recording medium having unevenness, and an optical recording medium having unevenness.

### BACKGROUND ART

Typically, in an optical recording medium on which reproducing and/or recording is conducted by light, such as a CD-ROM (Compact Disc-Read Only Memory), a magneto-optical recording medium having a magneto-optical recording layer, a phase change recording medium having a phase change recording layer or the like, unevenness such as recording pits, tracking grooves or the like is formed on a substrate such as a disk, a card or the like.

As for a method for fabricating such an optical recording medium having unevenness, an optical recording medium substrate having desired unevenness is fabricated by using a stamper having an inverted unevenness pattern corresponding to the unevenness, and injection molding or molding using the so-called 2P method (Photopolymerization method).

On the optical recording medium substrate having the unevenness pattern, the above described magneto-optical recording layer, or the like phase change recording layer, and a protection layer are formed. A desired optical recording medium is thus manufactured.

As for the fabrication of the above described stamper, typically a master disk is fabricated and plated with, for example, Ni, or the master disk and the Ni plating layer is peeled off from the master disk. A stamper is thus transferred and fabricated. Or a master stamper is transferred from a master disk and fabricated. A mother stamper is fabricated by transfer and duplication of the master stamper. From this mother stamper, a stamper to be used in the above described injection molding or molding of the 2P method is transferred and fabricated.

As for fabrication of the master disk, a photoresist layer is applied to a smoothed surface of a substrate made of, for example, alkali-containing glass, quartz or metal, and pattern exposure and development are conducted. As a result, a master disk having an unevenness pattern formed thereon is obtained. The unevenness pattern is prescribed in height by the thickness of the photoresist layer itself.

If it is attempted to achieve a recording capacity of, for example, 15 GB without changing a size in a DVD (digital versatile disc) currently having a recording capacity of, for example, approximately 4.7 GB, then it is demanded to make unevenness on the disk finer.

Making finer depends upon the resolution in the pattern exposure for the photoresist layer. As factors for determining the resolution, a wavelength of an exposure light source and a numerical aperture (N.A.) of its condenser object lens can be mentioned.

Supposing the exposure wavelength is _{″}, a resolution R obtained when the photoresist is used is represented by the Raighly's resolution limit equation (1).

R=0.61×λ/N·A (1)

FIG. 5 shows relations among the exposure length _{″}, and a minimum pitch length and a track pitch of an optical disk obtained from a master disk fabricated by using the exposure wavelength _{″} on the basis of the equation (1). The N.A. is set equal to 0.9.

When the wavelength is 351 nm, the resolution limit becomes approximately 0.240 _{″}m on the basis of the equation (1). A disk fabricated on the basis of this master disk can have a capacity of approximately 12 GB with a minimum pit length of 0.25 _{″}m, a track pitch tp of 0.47 _{″}m and a DVD size.

On the other hand, in the case where a light source of _{″}=266 nm is used, the resolution limit becomes approximately 0.18 _{″}m. With a minimum pit length of 0.41 _{″}m, a track pitch tp of 0.19 _{″}m and the DVD size, a capacity of approximately 15 GB becomes possible.

By using a novolac photoresist as a photoresist layer and exposure conducted by an optical system having a wavelength of 266 nm and an object lens N.A. of 0.90, a master disk is fabricated. By using the master disk thus fabricated, a stamper is fabricated. In an optical disk fabricated by using the stamper, a practical jitter value of 6.6% at 15 GB is achieved with a reproduction optical system having a wavelength of 532 nm and N.A.=0.94.

In recent years, however, not only simple formation of fine patterns, but also uniformity of individual patterns, mitigation of edge roughness of the formed patterns, and control of inclination angles of the side walls of the unevenness are required of optical disks.

The reason will now be described. As the recording density of the optical recording medium becomes higher, reproducing light for the optical recording medium is shortened in wavelength, such as from near infrared rays to blue-violet. In addition, the N.A. of an optical lens in an optical pickup is increased. As a result, the spot size of the reproducing light is reduced. Therefore, the MTF (Modulation Transfer Function) is increased. The shape of unevenness that has not become a cause of jitter heretofore exerts an influence upon jitter. That is the reason.

Simply comparing a spot size of a CD having a wavelength of 780 nm and a lens N.A. of 0.45 with a read spot size in the case where blue-violet light is used, the wavelength is 405 nm and the lens N.A. is 0.85, contraction to 0.27 times is conducted. It can be mentioned as a main cause.

Jitter causes of optical disks are represented by the following equation (2).

(Jitter)²=(disk noise)²+(crosstalk)²+(influence of intersymbol interference)²+(electrical noise )² (2)

In this way, jitter causes are classified into disk noise caused by the land area and pit shape, influence of crosstalk from adjacent tracks, influence of intersymbol interference before and after the pit, and electrical noise depending on the player or the like.

As for the crosstalk and the intersymbol interference among them, it is already conducted in CDs to reduce them by introducing recording compensation.

In other words, for example, a reproduced signal waveform is analyzed. And simulation is conducted so as to minimize the intersymbol interference and crosstalk by displacing the pit positions lightly before or after. Its result is fed back to a signal generator and cutting is conducted again. A method for reducing the intersymbol interference noise by repeating the series of processes is adopted.

As for the disk noise, however, it is caused by nonuniformity of the photoresist pattern formed by the exposure and development, edge roughness, and roughness of the photoresist itself. Since they are random quantities, it is extremely difficult to remove the noise by using an electric circuit, and a composition adjustment of the photoresist is needed in many cases.

As the development of high density disks are advanced by shorter wavelengths and higher N.A.s, the disk noise has become dominant.

As an example, a ROM disk of 20 GB is mentioned. In a disk structure having a track pitch of 0.36 _{″}m, a bit length of 0.13 _{″}m/bit, a thickness of an optical transmission layer between recording layers of the light incidence side being 100 _{″}m, a reflection factor of a reflection film disposed in the rear of the recording layer, jitter values are measured with a reproducing optical system having a Kr laser of 407 nm in wavelength and an N.A. of 0.85, and its causes are analyzed. Results are as follows.

| | |
|---|---|
| Whole jitter | 8.60% |
| Disk noise | 5.30% |
| Crosstalk | 4.90% |
| Intersymbol interference | 4.40% |
| Electrical noise | 1.50% |

The disk noise is thus dominant. It is extremely difficult to reduce the disk noise by using a conventional manufacturing method.

In the case where recording/reproducing operation is conducted from the film forming side as in the optical recording medium using blue violet light, the shapes of the reflection film and the recording layer become extremely important. It becomes indispensable to control, for example, the shape of unevenness on the glass master disk, i.e., the side wall inclination angle, roughness of the side wall surfaces and edge shape of the pit or groove shape.

In order to solve the above described problem, the control of the shape has a tendency to be recently improved by introducing a dry etching process using reactive ion etching into a master disk fabrication process of an optical recording medium such as an optical disk.

Even if such a method is used, however, a further hollow, i.e., a so-called subtrench 102 occurs in corner portions of the bottom of a trench, i.e., a concave portion 101 formed on a substrate 100 by typical dry etching as shown in a schematic sectional view of FIG. 6.

Therefore, the shape of the subtrench is transferred to a stamper formed by using the master disk. On an optical recording medium substrate fabricated by using the stamper and the injection molding or the 2P method, a shape disorder caused by the subtrench occurs in its convex portion or concave portion. If the reflection film and the recording layer forming the information recording layer are formed on the unevenness thus formed, therefore, the coverage of the film formation is lowered and becomes nonuniform, resulting in hindrance such as an increase of the error rate or an increase of the disk noise.

### DISCLOSURE OF INVENTION

An object of the present invention is to improve disk noise and jitter that pose a problem when reactive ion etching is applied to fabrication of a master disk to be used for fabrication of a desired optical recording medium.

In accordance with the present invention, a manufacturing method of a master disk for fabricating an optical recording medium having unevenness includes a step of forming a photoresist layer using a fine pattern corresponding to the unevenness on a surface of a substrate that forms the master disk, a first etching step of forming unevenness on the surface of the substrate by using the photoresist layer as a mask and using reactive ion etching, and a second etching step of conducting oxygen ion etching on the substrate with the photoresist layer removed or without removing the photoresist layer, after the first etching step.

In the manufacturing method of a master disk, in the second etching step, surface roughness of the substrate of the master disk, i.e., roughness of side walls, bottom and top surface is made 0.3 nm or less in rms (root mean square) (hereafter simply referred to as surface roughness) at the second etching step.

Furthermore, a manufacturing method of a stamper for fabricating an optical recording medium having unevenness includes a step of forming a photoresist layer on a surface of a substrate that forms the master disk, using a fine pattern corresponding to the unevenness, a first etching step of forming unevenness on the surface of the substrate by using the photoresist layer as a mask and using reactive ion etching, and a second etching step of conducting oxygen ion etching on the substrate after the first etching step. A master disk having unevenness is thus fabricated. The unevenness of the master disk is transferred at least once. In other words, a desired stamper for fabricating an optical recording medium is fabricated by conducting transfer once. Or, a desired stamper for fabricating an optical recording medium is fabricated by conducting transfer a plurality of times and fabricating a master stamper and a mother stamper.

Furthermore, a manufacturing method of an optical recording medium having unevenness includes a step of forming a photoresist layer on a surface of a substrate that forms the master disk, using a fine pattern corresponding to the unevenness, a first etching step of forming unevenness on the surface of the substrate by using the photoresist layer as a mask and using reactive ion etching, a second etching step of conducting oxygen ion etching on the substrate after the first etching step, a step of fabricating a master disk for fabricating an optical recording medium, via the forming step, the first etching step and the second etching step, fabricating a stamper by transferring the master disk at least once, and shaping an optical recording medium substrate having unevenness by using the stamper, and a step of forming an information recording layer on a surface having the unevenness of the optical recording medium substrate. An optical recording medium is thus fabricated.

In other words, in fabricating a master disk or a stamper according to the present invention, a pattern of a photoresist layer is fabricated and first etching using dry etching, which is excellent in controllability, is conducted by using the pattern as a mask. Thereafter, without removing the photoresist or after removing the photoresist, oxygen ion etching is conducted. It has been found that the subtrench generated by the first etching and described with reference to FIG. 6 can be excluded. As a result, the surface roughness can be improved.

In other words, according to the present invention, it has been found that subtrenches are excluded and it can be avoided that corner portions of the trench bottom take sharp shapes when a method contradicting the conventional common sense that etching is not conducted by oxygen ions is adopted.

And a stamper for shaping an optical recording medium, or a master stamper or a mother stamper for transferring the stamper can be fabricated by transfer from the master disk. Finally, therefore, an optical recording medium that is excellent in shaping property and surface property can be fabricated by injection molding or molding using 2P method. An optical recording medium improved in error rate and media noise can be obtained.

The master disk for fabricating an optical recording medium obtained according to the present invention can be used to fabricate a stamper. However, the master disk itself can be used as a stamper for fabricating an optical recording medium or as a master stamper or a mother stamper for fabricating the stamper.

### BRIEF DESCRIPTION OF DRAWINGS

FIGS. 1A, 1B and 1C are first process diagrams showing an example of a manufacturing method of a stamper for fabricating an optical recording medium according to the present invention;

FIGS. 2A, 2B and 2C are second process diagrams showing an example of a manufacturing method for fabricating an optical recording medium according to the present invention;

FIG. 3A is a diagram showing a relation between an etching rate and an ion incidence angle of oxygen ion etching;

FIG. 3B is a schematic sectional view showing an etching situation of oxygen ion etching;

FIG. 4 is a diagram showing a measurement result of a relation between surface roughness of oxygen ion etching and oxygen ion etching time;

FIG. 5 is a diagram showing a relation among a wavelength _{″} of an exposure light source for photoresist in master disk fabrication and a minimum pit length and a track pitch on an optical disk fabricated by using this master disk; and

FIG. 6 is a schematic sectional view of a concave portion formed by dry etching using reactive ion etching.

### BEST MODE FOR CARRYING OUT THE INVENTION

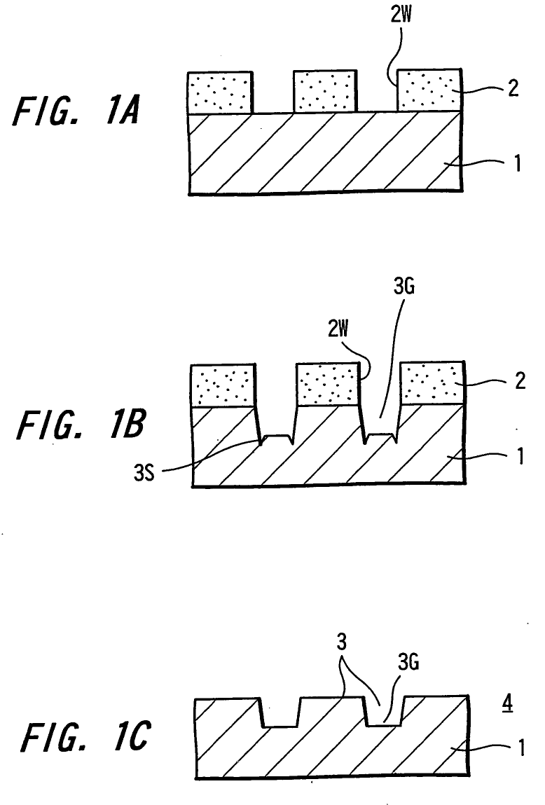

First, an example of an embodiment of a manufacturing method of a master disk for obtaining an optical recording medium fabrication stamper according to the present invention will now be described with reference to FIG. 1.

As shown in FIG. 1A, a substrate 1 for master disk fabrication, such as an alkali-containing glass substrate, a quartz substrate, a Si substrate, or a metal substrate, is prepared. A surface of the substrate 1 is formed as a smooth surface.

On the smooth surface of the substrate 1, a photoresist layer 2 having a pattern corresponding to an unevenness pattern of a desired optical recording medium is formed.

The pattern of the photoresist layer 2 can be formed by conducting application and formation of the photoresist layer, pattern exposure, and development processing.

As for exposure of the photoresist layer, a predetermined pattern can be exposed by exposing a predetermined pattern to, for example, laser light, electron beams, or an X ray through an exposure mask according to a well-known method, or scanning the photoresist layer with exposure light subjected to on-off modulation.

Thereafter, the photoresist layer 2 exposed in pattern is developed by using, for example, an organic or inorganic alkali developing solution. An opening 2W having a required pattern is thus formed.

For example, in the case where the photoresist layer 2 is photoresist of positive type, the opening 2W is formed in an exposure portion.

Subsequently, as shown in FIG. 1B, first etching using dry etching is conducted on the surface of the substrate 1 through the opening 2W of the photoresist layer 2 by using the photoresist layer 2 as an etching mask and using, for example, reactive gas, such as CHF₃, CF₄, C₃F₈, C₄F₈, or C₅F₈, or gas obtained by mixing one of these gases with oxygen or argon. Unevenness 3 having a concave portion 3G formed on the surface of the substrate is formed by the first etching.

A subtrench 3s occurs on the bottom of the concave portion 3G of the unevenness 3 thus formed.

Thereafter, as shown in FIG. 1C, the photoresist layer 2 is removed. The substrate 1 having the unevenness 3 formed by using the first etching is disposed in a chamber of a dry etching system, and oxygen gas is flown in the chamber. High frequency power is set to form plasma, and second etching is conducted.

By doing so, the sharp portion formed by the subtrench 3s disappears. In addition, unevenness having an excellent surface property on its side walls, bottom and top is formed. The reason is considered as follows. Oxygen gas in the chamber is ionized in the form of O₂⁺. This collides against the substrate 1 of the cathode potential side. Constituent atoms of the ion collision face of the substrate 1, such as Si atoms on a glass substrate, a quartz substrate, or a SiO₂ substrate, are sputtered. The atoms of the ion collision face are thus chipped off.

In this way, there is formed a master disk 4 having unevenness that is excellent in shaping property and in surface property with surface roughness of 0.3 nm or less formed thereon.

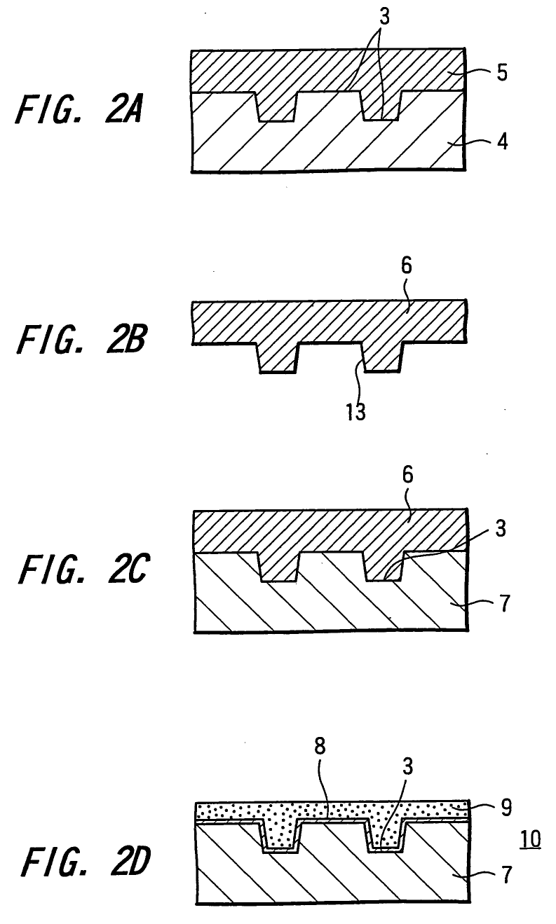

An example of an embodiment of method for manufacturing a stamper and an optical recording medium having unevenness according to the present invention will now be described with reference to FIG. 2.

In this embodiment, a master disk 4 is fabricated by using methods similar to those of FIGS. 1A to 1C as described above. As shown in FIG. 2A, a stamper material 5 is formed on the master disk 4 by using, for example, electroless plating of Ni and electroplating.

As shown in FIG. 2B, the stamper material 5 is peeled from the master disk 4. In this way, a stamper 6 to which the unevenness 3 of the master disk 4 has been transferred, i.e., a stamper 6 having unevenness 13 which is an inverted pattern of the unevenness 3 formed thereon is formed.

Since in the unevenness 3 of the master disk 4 subtrenches are excluded and the surface property of the unevenness is excellent, the unevenness 13 of the stamper 6 formed by using the method of the present invention has an excellent uniform shape and a high surface property with surface roughness of 0.3 nm or less, in the same way.

In the present invention, an optical recording medium is fabricated by using the stamper 6 thus formed.

For this purpose, as shown in FIG. 2C, an optical recording medium substrate 7, such as an optical disk substrate, to which the unevenness 13 of the stamper 6 has been transferred, i.e., an optical recording medium substrate 7 having unevenness 3 is first fabricated by using the injection molding or the 2P method.

For example, in the formation of an optical recording medium using a CD-ROM, an information recording layer 8 is formed by sputtering, for example, an Al reflection film on the surface of the optical recording medium substrate 7 forming the unevenness 3 thus formed as shown in FIG. 2D. For example, in a write-once CD, a magneto-optical recording medium, and a phase change optical recording medium, a pigment layer, a magneto-optical recording layer, a phase change material layer, a dielectric layer, and a reflection film are formed to form an information recording layer 8. Furthermore, a protection film 9 is formed on the information recording layer 8 by using a spin coat of transparent resin. A desired optical recording medium 10 is thus fabricated.

In the optical recording medium 10 thus formed, there are no subtrenches on the unevenness of the optical recording medium substrate 7. Therefore, the information recording layer formed on the unevenness is excellent in coverage, shape uniformity and surface property. As a result, the error rate and the noise are improved. The optical recording medium 10 is formed as an optical recording medium having the disk noise of −70 dB or less.

In the above described embodiment, the stamper 6 is formed by transfer of the above described master disk 4. In another embodiment, however, it is also possible to form a master stamper by transfer from the master disk 4, form a mother stamper by transfer from the master stamper, and fabricate the stamper 6 by transfer from the mother stamper.

In the above described embodiment, the master disk 4 is fabricated and the stamper 6 is fabricated by using the master disk 4. In the procedure of the master disk 4 shown in FIG. 1, however, so to speak the master disk itself may be used directly as the stamper 6, or may be used as a master stamper or a mother stamper for forming the stamper 6. In these cases, an exposure pattern for the photoresist layer 2 is selected so as to form the unevenness 3 or the unevenness 13 obtained by inverting the unevenness 3 suitably.

As described above, the present invention has a feature in conducting the second etching using oxygen ion irradiation. Unevenness is formed with excellent surface and shape properties by the oxygen ion etching.

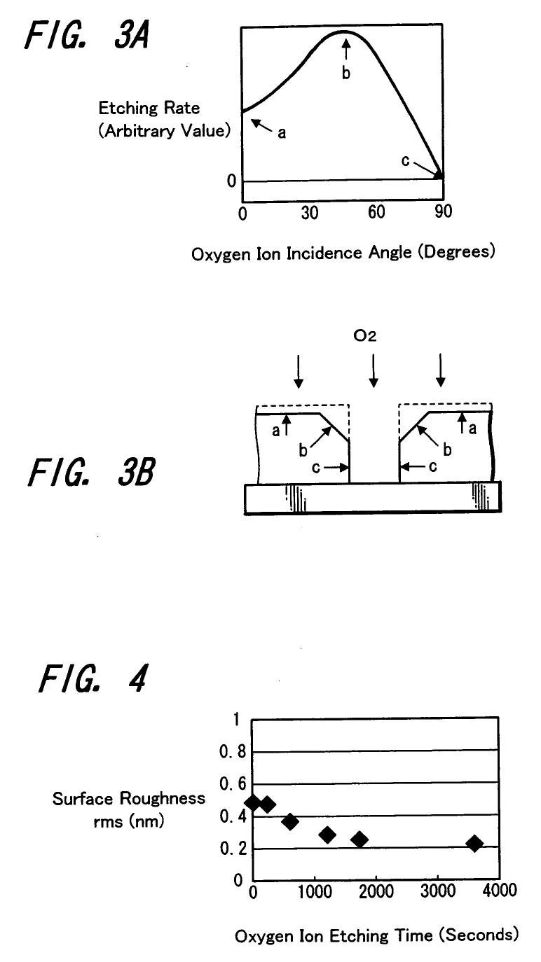

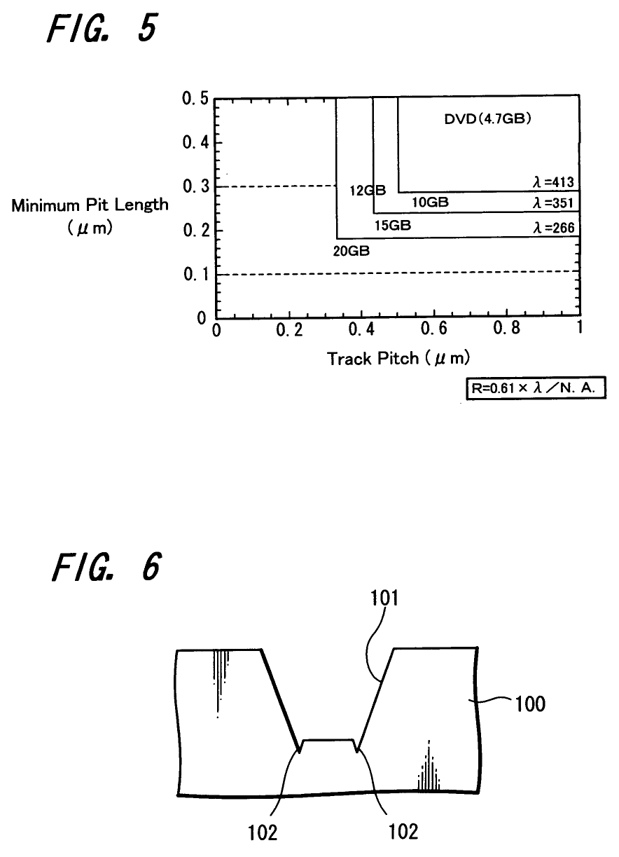

It is considered that this is caused by the following phenomenon. The sputter etching rate conducted by oxygen ions depends on the incidence angle of oxygen ions as shown in FIG. 3A. The etching rate is maximized at an incidence angle of 45°.

It is now supposed that oxygen ion etching is conducted on, for example, SiO₂ having a rectangular parallelepiped shape as its initial shape as represented by broken lines in FIG. 3B. This etching is advanced from the top face, and a plane “a”, which is substantially parallel to the top face, is formed. In sharp shoulder portions, however, etching proceeds in the side faces as well. Since the etching rate at 45° is maximum, a slope “b” of approximately 45° is generated. In side walls “c” of a concave portion of the unevenness, however, collision of oxygen ions is hard to occur, and consequently the etching proceeds little.

In FIG. 3A, “a” to “c” represent etching rates corresponding to the faces “a” to “c” in FIG. 3B.

In the shoulder portion and the sharp bottom portion of the subtrench described with reference to FIG. 6, therefore, etching using oxygen ion irradiation is conducted favorably, The subtrench disappears and smooth corner portions are formed. Furthermore, on the rough surface as well, etching is conducted in the same way and the surface property is improved.

The oxygen ion etching will now be described with reference to embodiments.

[First Embodiment]

A photoresist (GX250ESL:JSR) layer having a thickness of 100 nm is applied to a quartz substrate having a diameter of 200 mm and a thickness of 6 mm. By using an object lens having an N.A. of 0.9 and Kr laser light having a wavelength of 413 nm, pattern exposure is conducted, and development is effected to form a required pattern.

First etching, which is dry etching using CF₄ gas, is conducted from the surface of the substrate 1 by using the photoresist layer as an etching mask. As a result, grooves each corresponding to the concave portion, i.e., tracking guide grooves in this case are formed.

Thereafter, the photoresist layer is removed by ashing. The substrate 1 having grooves formed thereon is inserted into a dry etching system (NE 730: Japan Vacuum Technology) using the inductive super magnetron technique, and oxygen ion etching is conducted. A measured result of surface roughness (rms: root square mean) on the flat end surface of the unevenness of the substrate 1 with etching time elapse at this time is shown in FIG. 4.

The surface roughness is measured by using an AFM (atomic force microscope). Measurements are effected in ten positions in a range of 1 _{″}m in the tangential direction and 300 nm in the radial direction on the surface of the substrate 1, and rms values are obtained.

In this case, the initial roughness 0.48 nm is reduced to 0.3 nm or less, i.e., 0.28 nm 1200 seconds (20 minutes) later, and reduced to 0.22 nm 3600 seconds (60 minutes) later.

A similar tendency is shown in the grooves as well. Although the initial rms value is 0.51 nm, it is lowered to 0.3 nm or less by oxygen plasma etching. Namely, the rms value falls to 0.24 nm after the oxygen plasma etching is conducted for 20 minutes.

The Ni stamper described with reference to FIG. 2 is fabricated from the master disk. A disk substrate made of polycarbonate (PC) resin having a disk thickness of 0.5 mm is fabricated by using the stamper and injection molding. Without forming any film thereon, the disk noise is evaluated by using a reproduction evaluation apparatus.

Oxygen ion etching conditions, a groove disposition pattern, and a reproduction evaluation apparatus system for the unevenness in the first embodiment are shown below.

| | |
|---|---|
| Oxygen ion etching conditions: | |
| Antenna power | 200 W |
| Bias power | 20 W |
| Oxygen flow | 25 sccm |
| Pressure | 1.0 Pa |
| Substrate cooling temperature | 20° C. |
| Groove disposition pattern: | |
| Groove pitch | 0.76 _{″}m |
| Groove duty | 50% |
| Groove depth | 35 nm |

Reproduction evaluation system:

| | |
|---|---|
| Laser wavelength | 403 nm |
| Laser power | 2.5 mW |
| N.A. of optical system | 0.60 |
| Line velocity | 4 m/second |
| Accumulation frequency | 500 Hz to 10 MHz |

The surface roughness and the disk noise are measured at this time.

In an initial stage before the oxygen ion etching, the surface roughness rms in a land portion (on the surface between grooves) measures 0.48 nm and the disk noise measures −68.2 dB. In the grooves, the surface roughness rms measures 0.51 nm and the disk noise measures −63.7 dB.

After second etching in which oxygen plasma etching is conducted on the disk for 20 minutes under the above described conditions, the surface roughness rms in the land portion measures 0.28 nm and the disk noise in the land portion measures −78.4 dB, whereas the surface roughness rms in the grooves measures 0.24 nm and the disk noise in the grooves measures −81.5 dB. It is thus confirmed that the surface roughness and the disk noise have been greatly improved.

[Second Embodiment]

Photoresist having a thickness of 100 nm is applied to a quartz substrate similar to that of the first embodiment. Pattern exposure is conducted by using a N.A. of 0.9 and a Kr laser having a wavelength of 413 nm. Development processing is conducted to form a photoresist pattern.

The surface of the substrate is subjected to dry etching using CF₄ and using the photoresist layer as an etching mask. Grooves each serving as the uneveness in the same way as the first embodiment are thus formed.

Thereafter, the photoresist layer is removed by using an organic resist removing agent (Tokyo Ohka: Breaking away solution 105).

Thereafter, oxygen ion etching is conducted by using a dry etching system similar to that of the first embodiment. The etching conditions are listed below.

| | |
|---|---|
| Antenna power | 300 W |
| Bias power | 10 W |
| Oxygen flow | 50 sccm |
| Pressure | 1.0 Pa |
| Substrate cooling temperature | 15° C. |

Under the etching conditions, oxygen ion etching is conducted.

By using the stamper thus formed, a disk substrate made of polycarbonate (PC) resin and having a disk thickness of 0.5 mm is fabricated by injection molding in the same way as the first embodiment.

Measurement results of shape changes of grooves, i.e., inclination angles of each side face of the upper end side and the bottom side, groove duty and subtrench height of grooves on the master disk in the second embodiment in the case where the oxygen ion etching is conducted for five minutes and in the case where the oxygen ion etching is conducted for twenty-five minutes are shown in TABLE 1.

TABLE 1

| | Groove inclination angle | | | |
|---|---|---|---|---|
| | Upper end side | Bottom end side | Groove | Subtrench |
| | (degrees) | (degrees) | duty (%) | height (nm) |
| Oxygen | 45 | 38.4 | 47 | 1.6 |
| etching 5 | | | | |
| minutes | 42.5 | 28 | 50 | 0 |
| Oxygen | | | | |
| etching 25 | | | | |
| minutes | | | | |

As described above, the master disk fabricated according to the manufacturing method of the present invention is improved in shaping property of unevenness.

As described above, according to the present invention, a master disk and a stamper that are excellent in performance are fabricated. In a disk according to the present invention fabricated by using the master disk and the stamper, therefore, the disk noise is improved. This is because the unevenness on the stamper, i.e., the surface property of the side faces, bottom face, and the top face of the grooves and lands in the above described example is improved and smooth bending obtained by removing edges and subtrenches of the grooves and lands are formed, and consequently the characteristics are improved.

On the disk improved in the disk noise, the reflection film described with reference to FIG. 2 is formed to form the information recording layer 8. Or the pigment layer, the magneto-optical recording layer, the phase change material layer, the dielectric layer, and the reflection film are formed to form the information recording layer 8. And the protection film 9 is formed, and the optical recording medium 10 is thus fabricated. The optical recording medium 10 is excellent in the recording or reproducing characteristics and has an improved yield.

In the optical recording medium 10 thus fabricated, its protection film 9 is formed as a light a transmission layer of, for example, 100 _{″}m. Laser light of, for example, a blue-violet color is supplied to the optical recording medium 10 from the protection film 9 side to conduct recording/reproducing operation.

In the above described example, a disk is fabricated. As a matter of course, however, similar effects are obtained even if the present invention is applied to a card or various recording media.

As described above, by only conducting the oxygen ion etching in addition to the dry etching using the ordinary reactive ion etching in fabrication of a master disk for obtaining an optical recording medium fabricating stamper having unevenness according to the present invention, a master disk that is excellent in shaping property and surface property can be fabricated.

Furthermore, in the manufacturing method of a optical recording medium according to the present invention, an optical recording medium is manufactured via the manufacturing method of an optical recording medium fabrication stamper or a master disk for obtaining the stamper according to the above described present invention method. Therefore, an optical recording medium that is excellent in the recording or reproducing characteristics can be manufactured. This results in an industrially great effect that the yield is improved and mass productivity is improved.

1. A manufacturing method of a master disk for fabricating an optical recording medium having unevenness, said manufacturing method comprising:
a step of forming a photoresist layer having a fine pattern corresponding to said unevenness, on a surface of a substrate;
a first etching step of forming unevenness on said surface of said substrate by using said photoresist layer as a mask and using reactive ion etching; and
a second etching step of conducting oxygen ion etching on said substrate after said first etching step.

2. A manufacturing method of a master disk for fabricating an optical recording medium having unevenness according to claim 1, wherein surface roughness of said substrate is made 0.3 nm or less in rms (root mean square) at said second etching step.

3. A manufacturing method of a master disk for fabricating an optical recording medium having unevenness according to claim 1 or 2, wherein said substrate is a quartz substrate.

4. A manufacturing method of a stamper for fabricating an optical recording medium having unevenness, said manufacturing method comprising:
a step of forming a photoresist layer having a fine pattern corresponding to said unevenness, on a surface of a substrate;
a first etching step of forming unevenness on said surface of said substrate by using said photoresist layer as a mask and using reactive ion etching;
a second etching step of conducting oxygen ion etching on said substrate after said first etching step.
a step of fabricating a master disk via said forming step, said first etching step and said second etching step; and
a step of fabricating a stamper for fabricating an optical recording medium, by transferring unevenness of said master disk at least once.

5. A manufacturing method of an optical recording medium having unevenness, said manufacturing method comprising:
a step of forming a photoresist layer having a fine pattern corresponding to said unevenness, on a surface of a substrate;
a first etching step of forming unevenness on said surface of said substrate by using said photoresist layer as a mask and using reactive ion etching;
a second etching step of conducting oxygen ion etching on said substrate after said first etching step;
a step of fabricating a master disk for fabricating an optical recording medium, via said forming step, said first etching step and said second etching step;
a step of fabricating a stamper by transferring said master disk at least once;
a step of shaping an optical recording medium substrate having unevenness by using said stamper; and
a step of forming an information recording layer on a surface having said unevenness of said optical recording medium substrate.
